(19) United States
(12) Patent Application Publication
(10) Pub. No.: US 2026/0166845 A1
(43) Pub. Date: Jun. 18, 2026

(54) SURFACE MATERIAL AND INTERIOR MATERIAL

(71) Applicants: HONDA MOTOR CO., LTD., Tokyo (JP); NIHON PLAST CO., LTD., Fujinomiya-shi (JP)

(72) Inventors: Yasushi Fujikura, Tokyo (JP); Takaaki Seki, Shizuoka (JP)

(21) Appl. No.: 19/413,165

(22) Filed: Dec. 9, 2025

(30) Foreign Application Priority Data
Dec. 16, 2024 (JP) 2024-220202

(51) Int. Cl. B32B 7/09; B32B 9/02; B60R 13/02

(52) U.S. Cl. CPC B32B 7/09; B32B 9/025; B32B 2250/02; B32B 2317/08; B32B 2605/003; B60R 13/02

(57) ABSTRACT

Provided are: a surface material that can improve the visual quality with a simple configuration; and an interior material including the same. A surface material is formed of a synthetic resin. The surface material includes: an ordinary portion; and a sewing-scheduled portion to be sewn with a sewing thread. At least a part of the sewing-scheduled portion includes a weak reaction force portion where a reaction force to the sewing thread is set to be weaker than that of the ordinary portion.

### CROSS REFERENCE TO RELATED APPLICATIONS

The disclosure of Japanese Patent Application No. 2024-220202 filed on Dec. 16, 2024 including the specification, drawings and abstract is incorporated herein by reference in its entirety.

### TECHNICAL FIELD

The present invention relates to a surface material formed of a synthetic resin and an interior material including the same.

### BACKGROUND ART

In the related art, for example, in an interior material used for a vehicle such as an automobile, a surface material may be bonded to a base material to improve the visual quality. In addition, in order to further improve the visual quality, there is a case where a plurality of surface materials may be joined by primary sewing and a design surface may be stitched (secondary sewing).

As the interior material, recently, a configuration where a leather formed of a synthetic resin (synthetic leather) is bonded to a base material as a surface material instead of so-called genuine leather such as an animal leather is known (for example, refer to PTL 1).

### CITATION LIST

### Patent Literature

### PTL 1

Japanese Patent Application Laid-Open No. 2020-97302

### SUMMARY OF INVENTION

### Technical Problem

When a leather formed of a synthetic resin is used as a surface material, it is desirable that the leather looks like genuine leather to ensure the visual quality. For example, stitches may be formed by actually sewing the surface material with a thread to obtain the same texture and visual quality as in genuine leather.

However, the leather formed of a synthetic resin needs to have a certain thickness to ensure cushioning properties, and it is difficult to reduce the entire thickness. Therefore, depending on the material and the thickness, a reaction force to tightening of the thread tends to be stronger than that of genuine leather. Therefore, even when the same thread and the same sewing machine as in genuine leather are used, the three-dimensional appearance of the thread and a needle hole diameter are different from those of genuine leather, and only the stitches are conspicuous. As a result, the appearance may deteriorate. Regarding this point, for example, a case of using a thread and/or a sewing machine different from those of a case where genuine leather is used can also be considered, and a high cost is required for the adjustment.

The present invention has been in consideration of the above-described points, and an object thereof is to provide: a surface material that can improve the visual quality with a simple configuration; and an interior material including the same.

### Solution to Problem

A surface material according to an aspect of the present invention is a surface material that is formed of a synthetic resin, the surface material including: an ordinary portion; and a sewing-scheduled portion to be sewn with a sewing thread, in which at least a part of the sewing-scheduled portion includes a weak reaction force portion where a reaction force to the sewing thread is set to be weaker than that of the ordinary portion.

### Advantageous Effects of Invention

According to the present invention, it is possible to provide: a surface material that can improve the visual quality with a simple configuration; and an interior material including the same.

### BRIEF DESCRIPTION OF DRAWINGS

FIG. 1A is a front view showing a surface material according to Embodiment 1 of the present invention, and FIG. 1B is a cross-sectional view showing the surface material that has been sewn;

FIG. 2 is a cross-sectional view showing the surface material;

FIG. 3 is a perspective view showing an example of an interior material including the surface material;

FIG. 4 is a front view schematically showing a deviation of a penetration angle and a penetration position of a sewing needle into the surface material;

FIG. 5 is a cross-sectional view schematically showing Reference Example of the surface material;

FIG. 6 is a perspective view showing a surface material according to Embodiment 2 of the present invention; and

FIG. 7 is a cross-sectional view schematically showing Reference Example of the surface material; and

FIG. 8A is a front view showing a part of a surface material according to Embodiment 3 of the present invention, and FIG. 8B is a front view showing a part of a surface material according to Embodiment 4 of the present invention.

### DESCRIPTION OF EMBODIMENTS

Hereinafter, Embodiment 1 of the present invention will be described with reference to the drawings.

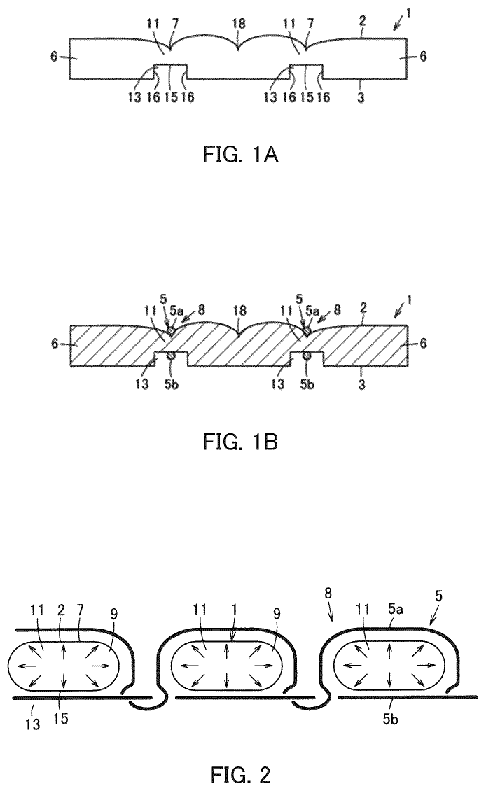

In FIGS. 1A, 1 represents a surface material. The surface material 1 is used to cover at least a part of a front surface as a target to be covered. Examples of the surface material 1 include leather that is formed of a synthetic resin (synthetic leather). The synthetic resin forming the surface material 1 is a material having a higher reaction force than, for example, genuine leather (natural leather). The surface material 1 has a flexible sheet shape and is formed by, for example, injection molding. The surface material 1 includes: a design surface 2 that is a front surface positioned on the outer side; and a counterface surface 3 that is a back surface positioned on the target side to be covered. An external shape of the surface material 1 has a quadrangular shape in the drawing, but can be appropriately set according to the target to be covered.

In order to improve the design, a part of the surface material 1 according to the present embodiment is sewn with a sewing thread 5 as shown in FIG. 1B. That is, in the surface material 1, an ordinary portion 6 and a sewing-scheduled portion 7 are set, and the sewing-scheduled portion 7 is sewn with the sewing thread 5 to form a sewn portion 8.

As shown in FIG. 2, in the present embodiment, the sewing thread 5 includes: an upper thread 5a of which a part is positioned on the design surface 2 to form a stitch that is a design of the sewn portion 8; and a lower thread 5b that is entangled with the upper thread 5a not to be exposed to the design surface 2 side. In the example shown in the drawing, the upper thread 5a is disposed in a wave-like shape to be entangled with the lower thread 5b on the back side from the design surface 2 through a needle hole 9 formed in the sewing-scheduled portion 7, and the lower thread 5b is disposed linearly on the back side of the design surface 2. The needle hole 9 may be formed by a sewing needle penetrating the surface material 1 at the position of the sewing-scheduled portion 7 in a thickness direction during sewing, and may be previously formed in the sewing-scheduled portion 7 before sewing.

The ordinary portion 6 shown in FIG. 1A is a so-called non-sewn portion that is not sewn, and forms, for example, the majority of the surface material 1. In the drawing, an example where the ordinary portion 6 has a constant or substantially constant thickness is shown. However, the present invention is not limited to this example, and an appropriate thickness may be set according to, for example, a front surface shape of a target to be covered.

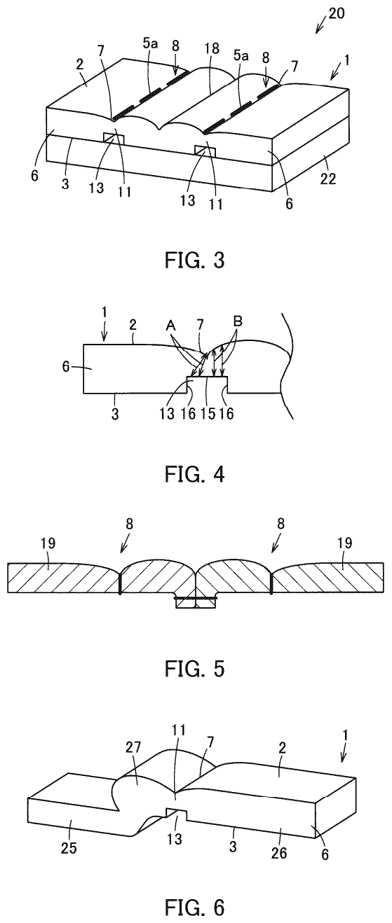

The sewing-scheduled portion 7 is formed such that the design surface 2 side is depressed in the thickness direction from the peripheral portion thereof. The sewing-scheduled portion 7 is formed along a predetermined line. In the drawing, an example where the sewing-scheduled portion 7 is formed along a straight line is shown. However, the present invention is not limited to this example, and the sewing-scheduled portion 7 may be formed along a curved line. In the example shown in the drawing, a pair of sewing-scheduled portions 7 are formed. These sewing-scheduled portions 7 are at positions that are at a constant or substantially constant distance from each other and parallel to each other. “Parallel” is generally an expression that defines a relationship between straight lines. However, the present embodiment is not limited to the relationship between straight lines, and a state where portions are positioned at a constant or substantially constant distance from each other along a predetermined line will be referred to as “parallel”. In this example, as shown in FIG. 3, a so-called double-stitched sewn portion 8 is formed to have a design where stitches formed in the sewing-scheduled portion 7 by the upper thread 5a of the sewing thread 5 are parallel to each other.

As shown in FIGS. 1A and 1B, a weak reaction force portion 11 is set in at least a part of the sewing-scheduled portion 7. The weak reaction force portion 11 is a portion where a reaction force to the sewing thread 5 is set to be weaker than that of the ordinary portion 6. The weak reaction force portion 11 is formed by making at least a part of the sewing-scheduled portion 7 thinner than the ordinary portion 6. In the example shown in the drawing, the weak reaction force portion 11 is formed by a concave portion 13 that is formed on the counterface surface 3 opposite to the design surface 2, and is positioned on the design surface 2 side of the concave portion 13. In the present embodiment, the concave portion 13 is formed in a groove shape that is continuous along a predetermined line where the sewing-scheduled portion 7 extends.

A maximum width of the concave portion 13 is set to be larger than a thickness of the sewing thread 5. The shape of the concave portion 13 may be freely set, and it is preferable that the concave portion 13 includes a bottom portion 15 and a side wall portion 16 that ranges from both sides of the bottom portion 15 to the counterface surface 3.

The bottom portion 15 is formed on the back side of the design surface 2 in the sewing-scheduled portion 7 in a planar shape that is parallel or substantially parallel to the counterface surface 3. As shown in FIG. 2, the lower thread 5b of the sewing thread 5 is positioned in the bottom portion 15 of the concave portion 13. In addition, both of the side wall portions 16 shown in FIG. 1A are perpendicular or substantially perpendicular to the bottom portion 15 in the present embodiment, and are formed parallel or substantially parallel to each other such that the concave portion 13 has a constant or substantially constant width.

In addition, in the ordinary portion 6, a groove portion 18 is formed between the sewing-scheduled portions 7 and 7 on the design surface 2, and the design surface 2 swells to be curved outward between the groove portion 18 and each of the sewing-scheduled portions 7. On the design surface 2 including the groove portion 18, for example, as shown in Reference Example of FIG. 5, for example, a design similar to a connection portion where terminal portions of a pair of surface pieces 19 formed of genuine leather (natural leather) are folded to face each other and to be connected to each other is exhibited. As a result, an impression is given as if the surface material 1 shown in FIG. 1A consists of a plurality of surface pieces, which improves the design. As shown in FIG. 3, the groove portion 18 is positioned parallel to the sewing-scheduled portions 7 and 7. That is, a stitch formed by the upper thread 5a of the sewing thread 5 is positioned on each of one side and the other side with reference to the groove portion 18.

When the sewing-scheduled portion 7 is sewn with the sewing thread 5 by means of, for example, a sewing machine, as shown in FIG. 2, the surface material 1 includes the weak reaction force portion 11 such that a reaction force to the tightening of the sewing thread 5 is weakened. As a result, the needle hole 9 is widened, and roundness of the sewing thread 5 and roundness of the surface material 1 in the design surface 2 of the sewing-scheduled portion 7 tightened by the sewing thread 5 and in an edge portion of the needle hole 9 are strengthened such that the three-dimensional appearance is obtained in the sewn portion 8. That is, by forming the weak reaction force portion 11, for example, while using the sewing thread 5, the sewing needle, the sewing machine, and the like as in the case where natural leather such as an animal leather, that is, so-called genuine leather is sewn, the three-dimensional appearance and the needle hole diameter in the sewn portion 8 can be made similar to those of the genuine leather. Accordingly, the visual quality can be improved with a simple configuration.

In addition, the weak reaction force portion 11 is formed by making at least a part of the sewing-scheduled portion 7 thinner than the ordinary portion 6. Therefore, the surface material 1 that can improve the visual quality can be formed at a low cost.

For example, in the present embodiment, the concave portion 13 is formed opposite to the design surface 2 in the surface material 1 such that the design surface 2 of the concave portion 13 forms the weak reaction force portion 11. As a result, a reaction force to the weak reaction force portion 11 can be easily adjusted by adjusting the depth of the concave portion 13.

In addition, since the concave portion 13 includes the bottom portion 15, the width of the bottom portion 15 is set to a predetermined width where penetration angle error (rotation deviation) and/or error (parallel deviation) of a penetration position of the sewing needle into the surface material 1 can be absorbed. As a result, for example, even when the penetration angle of the sewing needle during sewing deviates to some extent as indicated by arrow A in FIG. 4 or even when the penetration position of the sewing needle deviates to some extent as indicated by arrow B, the deviation is absorbed by the width of the bottom portion 15 of the concave portion 13. Thus, a variation in the reaction force to the sewing thread 5 forming the stitch can be suppressed, and a variation in the visual quality caused by the reaction force can be suppressed.

Further, the concave portion 13 can be easily formed, for example, by injection molding simply by being processed in a shape of a mold of the surface material 1.

As shown in FIG. 3, in the present embodiment, an example where the above-described surface material 1 is used for an interior material 20 is shown. The interior material 20 is configured such that at least a part that is a target to be covered of an interior material body portion 22 as a base material is covered with the surface material 1 for decoration. Examples of the interior material 20 include an automobile interior material provided in, for example, an automobile interior of a vehicle such as an automobile.

The interior material body portion 22 is formed in, for example, an appropriate shape using a rigid synthetic resin. The counterface surface 3 of the surface material 1 that is sewn with the sewing thread 5 is fixed, for example, by bonding to at least a part of a front surface of the interior material body portion 22. The surface material 1 is fixed to the interior material body portion 22 such that at least the sewing thread 5 of the sewing-scheduled portion 7 forms a part of the design of the interior material 20. The surface material 1 may be fixed to the interior material body portion 22 such that the terminal portion of the surface material 1 is folded from a terminal portion of the interior material body portion 22 to a rear surface side of the interior material body portion 22. The concave portion 13 is a portion that is not in contact with the front surface of the interior material body portion 22, and substantially has no effect on the design surface 2 side.

This way, the interior material 20 including the above-described surface material 1 has a high visual quality similar to, for example, genuine leather at a low cost.

Next, Embodiment 2 will be described with reference to FIG. 6. The same reference numerals are given to the same configurations and actions as in Embodiment 1, and the description thereof will be omitted.

In the surface material 1 according to the present embodiment, one sewing-scheduled portion 7 is set, and the upper thread 5a of the sewing thread 5 forms the so-called single-stitched sewn portion 8. The concave portion 13 is formed on the counterface surface 3 side in the sewing-scheduled portion 7, and the design surface 2 side of the concave portion 13 forms the weak reaction force portion 11.

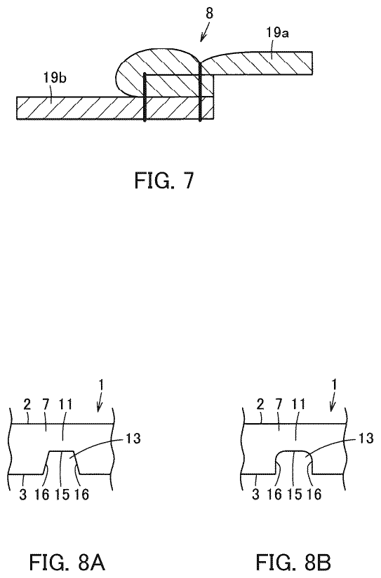

In addition, in the example shown in the drawing, in the surface material 1, a first portion 25 and a second portion 26 are continuously formed, the sewing-scheduled portion 7 is formed in a part of the second portion 26, and the remaining portion of the second portion 26 and the first portion 25 form the ordinary portion 6. In the first portion 25 and the second portion 26, the design surface 2 and the counterface surface 3 are formed stepwise, respectively. In a continuous portion where the first portion 25 and the second portion 26 are continuous to each other, a protrusion portion 27 is formed in a terminal portion of the second portion 26. The protrusion portion 27 is formed at a position adjacent to the sewing-scheduled portion 7. In the present embodiment, the protrusion portion 27 forming the terminal portion of the second portion 26 is formed parallel to the sewing-scheduled portion 7. The protrusion portion 27 is formed in a curved shape where the design surface 2 protrudes to the side opposite to the sewing-scheduled portion 7 in an arc shape. That is, the protrusion portion 27 expands to protrude to the first portion 25 side, and is continuous to the design surface 2 of the first portion 25 at a position on the second portion 26 side further than a tip of the expansion. That is, the front surface of the protrusion portion 27 is continuous to the design surface 2 of the first portion 25 at a position where the front surface is folded to be curved to the second portion 26 side. In a portion including the protrusion portion 27 and a peripheral portion thereof, as illustrated in Reference Example of FIG. 7, for example, at a position adjacent to the sewing-scheduled portion 7, a terminal portion of one surface piece 19a formed of genuine leather (natural leather) is folded to overlap, for example, a terminal portion of another surface piece 19b formed of genuine leather (natural leather), and a design similar to a connection portion where the terminal portions are connected to each other is exhibited. As a result, an impression is given as if the surface material 1 shown in FIG. 6 consists of a plurality of surface pieces, which improves the design.

This way, at least a part of the sewing-scheduled portion 7 includes the weak reaction force portion 11 where a reaction force to the sewing thread 5 is set to be weaker than that of the ordinary portion 6. As a result, when the sewing-scheduled portion 7 is sewn with the sewing thread 5, a reaction force to the tightening of the sewing thread 5 is weakened, and thus the needle hole 9 is widened, and roundness of the sewing thread 5 and roundness of the surface material 1 in the design surface 2 of the sewing-scheduled portion 7 tightened by the sewing thread 5 and in an edge portion of the needle hole 9 are strengthened such that the three-dimensional appearance is obtained in the sewn portion 8. Due to the above-described action as that of Embodiment 1, even in the surface material 1 including the sewn portion 8 having the single-stitched design, the same effect as that of Embodiment 1 can be exhibited in that the visual quality can be improved with a simple configuration.

In each of the embodiments, regarding the shape of the concave portion 13, for example, as in Embodiment 3 shown in FIG. 8A, both side wall portions 16 may be inclined to be gradually spaced from each other toward the counterface surface 3, and the concave portion 13 may be formed to be gradually widened toward the counterface surface 3. In addition, as in Embodiment 4 shown in FIG. 8B, a position where the bottom portion 15 and both side wall portions 16 are continuous to each other may be bent in a curved shape.

Further, the surface material 1 does not need to be used for the interior material 20, and may be used for any other targets to be covered.

### INDUSTRIAL APPLICABILITY

The present invention can be suitably used as a surface material for decorating, for example, an automobile interior material.

### REFERENCE SIGNS LIST

1 Surface material
2 Design surface
5 Sewing thread
6 Ordinary portion
7 Sewing-scheduled portion
11 Weak reaction force portion
13 Concave portion
15 Bottom portion
20 Interior material
22 Interior material body portion

What is claimed is:

1. A surface material that is formed of a synthetic resin, the surface material comprising:
an ordinary portion; and
a sewing-scheduled portion to be sewn with a sewing thread,
wherein at least a part of the sewing-scheduled portion includes a weak reaction force portion where a reaction force to the sewing thread is set to be weaker than that of the ordinary portion.

2. The surface material according to claim 1,
wherein the weak reaction force portion is formed by making the at least a part of the sewing-scheduled portion thinner than the ordinary portion.

3. The surface material according to claim 1, further comprising a concave portion that is formed opposite to a design surface and forms a side of the design surface in the weak reaction force portion,
wherein the concave portion includes a bottom portion.

4. An interior material comprising:
an interior material body portion; and
the surface material according to claim 1 that covers at least a part of the interior material body portion.

5. An interior material comprising:
an interior material body portion; and
the surface material according to claim 2 that covers at least a part of the interior material body portion.

6. An interior material comprising:
an interior material body portion; and
the surface material according to claim 3 that covers at least a part of the interior material body portion.
